(19) United States
(12) Patent Application Publication
(10) Pub. No.: US 2006/0260098 A1
(43) Pub. Date: Nov. 23, 2006

(54) Weight for Hand-Held Tools Such as Writing Instruments

(76) Inventors: Michelle J. Brown, Worcester, MA (US); Patrick Brown, Worcester, MA (US)

Correspondence Address: Brian M. Dingman, Esq.;Mirick, O'Connell, DeMallie & Lougee, 1700 West Park Drive, Westborough, MA, 01608, US

(21) Appl. No.: 11/383,780

(22) Filed: May 17, 2006

Related U.S. Application Data
(60) Provisional application No. 60/682,225, filed on May 18, 2005.

(51) Int. Cl. B25G 1/10

(52) U.S. Cl. 16/421

(57) ABSTRACT

A weight for placement on a hand-held tool that has an elongated body portion. The weight has a generally cylindrical body defining a through-hole that is larger in diameter than the elongated body portion of the tool, and at least one flexible member coupled to the body and extending inwardly from the ends of the body such that it effectively decreases the through-hole diameter. The body and flexible member combination is placed onto the tool such that the elongated body portion of the tool protrudes from both ends of the body, with the flexible member frictionally engaging the elongated body portion.

### CROSS REFERENCE TO RELATED APPLICATION

This application claims priority of Provisional application Ser. No. 60/682,225, filed on May 18, 2005.

### FIELD OF THE INVENTION

This invention relates to a removable weight for hand-held tools such as writing instruments.

### BACKGROUND OF THE INVENTION

The use of weighted utensils is well documented in literature to improve somatosensory input to the hand. Weighted pencils or pens have a weight held on to the pencil or pen with a rubber “o” ring or with a set screw. This makes them expensive, and relatively difficult to assemble. This costly item, when provided to an elementary school child, may be lost in one day. This has resulted in frustration to therapists who often purchase supplies on their own due to budget constraints in school settings.

### SUMMARY OF THE INVENTION

It is therefore a primary object of this invention to provide a specialized pencil to address the need for inexpensive sensory input. It follows from sensory integration theory that a child who has poor somatosensory input has difficulty processing movement. If we look closely at the hand and provide the same input that we provide to the body, we identify that a weighted pencil may provide input. This approach was utilized with two students over a six week period with samples of written work pre and post six weeks. Simple handwriting samples were obtained of writing name, and lower case alphabet on classroom lined paper. A second pencil was provided to the home for homework. The results were significant with both children. The first grade student was able to remain within lines and form letters correctly. His writing became legible on all classroom papers. He chose the 3″ long weight for his pencil. A third grade student was able to remain within lines, form letters in print and in cursive correctly. He tried all three different weights and decided on the 2″ and 3″ long weights for his pencil, for a total length of 5″. Although the writing tool alone showed significant results in the first grade student, the third grade student needed modification to his writing program.

Many approaches were used to develop skills in handwriting. The success of the weighted pencil, modified handwriting programs, behavior modification program and direct instruction in movement control resulted in a third grade child who smiles during school. Legibility in creative writing continues to be a struggle, but the referral to assistive technology was cancelled, as there is hope that he will be able to write.

The result of frustration has yielded a device with significant results in handwriting legibility in 2-6 weeks time. Four sizes of pencils have been made in the preferred embodiment. Several other options include using the weight over a primary crayon, regular sized crayon, marker, pen, primary pencil, oversized pen or other hand-held tool. The internal diameter of the pipe determines which size object it will fit over. Shrink tubing holds it into place so that it will not slide.

This invention features a weight for placement on a hand-held tool that has an elongated body portion. The weight has a generally cylindrical body defining a through-hole that is larger in diameter than the elongated body portion of the tool, and at least one flexible member coupled to the body and extending inwardly from the ends of the body such that it effectively decreases the through-hole diameter. The body and flexible member combination is placed onto the tool such that the elongated body portion of the tool protrudes from both ends of the body, with the flexible member frictionally engaging the elongated body portion.

The body may comprise a pipe nipple or a length of pipe. The flexible member may comprise plastic, and may be a sheath that covers the body. The flexible member may comprise heat shrink tubing that is shrunken onto the body. The heat shrink tubing may be longer than the body. The ends of the tubing may be inside of the body. The tubing may extend beyond both ends of the body. The weight may further comprise an adhesive between the inside of the body and the tool elongated body portion.

Featured in another embodiment is a weight for placement on a hand-held tool with an elongated body portion comprising a body comprising a length of pipe or a pipe nipple that defines a through-hole that is larger in diameter than the elongated body portion of the tool, and a plastic sheath that covers and is coupled to the body and extends inward from the ends of the body such that it effectively decreases the through-hole diameter, wherein the body and plastic sheath combination is placed onto the tool such that the elongated body portion of the tool protrudes from both ends of the body, with the flexible member frictionally engaging the elongated body portion.

The plastic sheath may comprise heat shrink tubing that is shrunken onto the body. The heat shrink tubing may be longer than the body. The ends of the tubing may be inside of the body. The tubing may extend beyond both ends of the body.

### BRIEF DESCRIPTION OF THE DRAWINGS

Other objects, features and advantages will occur to those skilled in the art from the following description of the preferred embodiments and the accompanying drawings in which:

FIG. 1 is a cross-sectional view of one preferred embodiment of the weight of this invention coupled to a pencil; and

FIG. 2 is a cross-sectional view of another embodiment of a weight of the invention.

### DETAILED DESCRIPTION OF THE PREFERRED EMBODIMENTS

The invention comprises a weight that can be removably coupled to a hand-held tool such as a pen, pencil, crayon, other writing implement, or other small tools that are held in one hand and have a tip or working end which needs to be carefully controlled by the user. Examples of such tools that are not writing instruments include mechanical engraving instruments, garden tools, artist tools, and small mechanical tools. The weight comprises two main portions. One portion is a generally cylindrical body. The generally cylindrical body defines a through-hole that is a bit larger in diameter than the elongated body portion of the tool that the weight will be placed on. The term “generally cylindrical” is not meant to imply that the body has a round cross-section or a through-hole with a round cross-section, as neither is a limitation of the invention. Although the embodiments shown in the drawings are essentially round, other shapes such as square, rectangular, or other geometric shapes could be used. The objective of the body is to provide some additional weight that can be coupled to the tool to assist in the user's manipulation of the tool.

The second portion of the inventive weight is a flexible member that is coupled to this body and extends inward from the ends of the body such that it effectively decreases the through-hole diameter. The effective diameter of the through-hole is decreased such that when the assembled weight is placed on the elongated body portion of the tool, the flexible member frictionally engages with that portion of the tool so that the weight is held on with sufficient force such that it doesn't fall off or move as the tool is used. The flexibility allows the effective diameter to expand as the weight is pushed on to the tool, and also to take the circumferential shape of the tool (to conform to the tool shape) in order to increase the frictional engagement between the weight and the tool. These functions will become apparent from the description of the preferred embodiments.

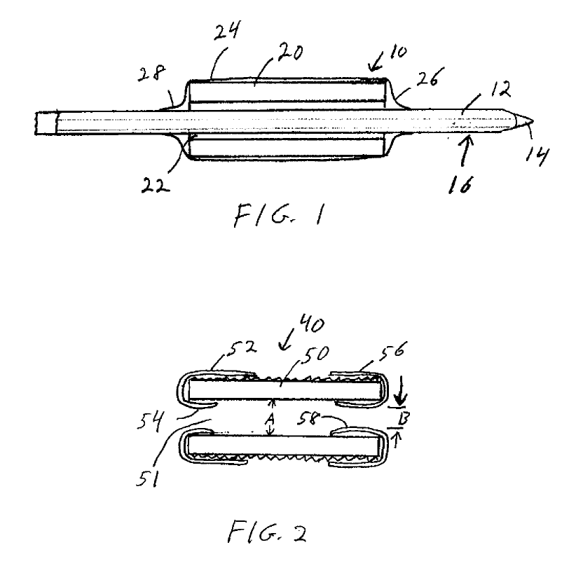

FIG. 1 shows a first preferred embodiment of inventive weight 10 that is placed on hand-held tool 12 with elongated body portion 16. In this example, tool 12 is a pen or pencil with writing tip 14. Weight 10 comprises generally cylindrical body 20 that defines through-hole 22 that is larger in diameter than elongated body portion 16 of tool 12 on which weight 10 is placed. Flexible member 24 in this case comprises a length of plastic heat-shrink tubing that typically is about one-quarter to one-half inch longer than the length of body 20 so that it protrudes about one-eighth to one-quarter of an inch from each end of the body at end sections 26 and 28. Flexible member 24 extends inward from the ends of body 20 toward its longitudinal axis such that it decreases the effective diameter of through-hole 22 to the point that weight 10 frictionally engages portion 16 of tool 12 with sufficient grip to hold the weight on the tool.

To assemble weight 10 onto the tool, weight 10 with member 24 is pushed over one end of tool 12 and moved to a desired location. In this case, the location is sufficiently spaced from tip 14 to allow a person to grip the tool between weight 10 and tip 14, as desired by the particular user. Since weight 10 can be slid along elongated body portion 16 of tool 12, the location is adjustable.

A second similar embodiment is shown in FIG. 2. Inventive weight 40 includes generally cylindrically body 50 and flexible members 52 and 56 coupled to body 50 with ends 54 and 58, respectively, that extend inward from body 50 such that they effectively alter the diameter of through-hole 51 from A to B. This drawing also illustrates that the function of the weight can be accomplished with one or more flexible members, and that the flexible member or member ends can extend outwardly from, and toward the longitudinal axis of, the body, as shown in FIG. 1, or can extend inwardly into the through-hole as shown by FIG. 2.

The cylindrical body can conveniently be made of a portion of pipe or the like as shown by body 20, FIG. 1, or a plumbing nipple as shown by body 50, FIG. 2. The particular sizes and lengths of some preferred embodiments for different applications are detailed below.

The weighted pencil can be easily made with two items from the local home improvement center.

Supplies for preferred embodiments for weights for standard wooden no. 2 pencils (The materials are easily purchased at a home repair store):

a. for the body:
2″×½″ nipple (plumbing supply department)
2.5″×½″ nipple
3″×½″ nipple

(alternatively, pipe having an inside diameter a bit larger than the elongated body portion of the tool, such as schedule 40 pipe, can be cut to a desired length, which can be less than or greater than the lengths set forth herein. For larger diameter tools, a larger diameter pipe or other cylindrical body can be used.)

b. for the flexible member:

Shrink tubing of a size that will fit over the body (electrical department)

Assembly directions:

1. Cut shrink tubing to extend about ¼″ beyond length of nipple/pipe

2. Push nipple/pipe into tubing and align evenly

3. Heat lightly with heat gun or over flame very briefly until tubing shrinks onto nipple/pipe. The tubing may be kept extended or pushed into the central through-hole of the body depending on the thickness of the tool.

4. Let cool.

5. Slide weight over pencil in a twisting motion.

6. Allow child to try the three different weights and decide which one or more will work best for the child.

An adhesive such as glue or rubber cement can be placed between the body and the flexible member and/or between the weight and the tool, to provide a more hold.

An alternative embodiment envisions placement of a weight inside of the tool, at a desired location. For example, some ballpoint pens have fairly wide chamber that has room for a cylindrical body that adds weight near the writing tip. In this case, depending upon the pen construction, the flexible member may not be necessary as the body is held in place within the pen chamber by virtue of the pen construction itself.

Although specific features of the invention are shown in some drawings and not others, this is not a limitation of the invention. Rather, the invention is defined by the following claims.

What is claimed is:

1. A weight for placement on a hand-held tool with an elongated body portion comprising
a generally cylindrical body defining a through-hole that is larger in diameter than the elongated body portion of the tool; and
at least one flexible member coupled to the body and extending inwardly from the ends of the body such that it effectively decreases the through-hole diameter;
wherein the body and flexible member combination is placed onto the tool such that the elongated body portion of the tool protrudes from both ends of the body, with the flexible member frictionally engaging the elongated body portion.

2. The weight of claim 1 in which the body comprises a pipe nipple.

3. The weight of claim 1 in which the body comprises a length of pipe.

4. The weight of claim 1 in which the flexible member comprises plastic.

5. The weight of claim 4 in which the flexible member comprises a sheath that covers the body.

6. The weight of claim 5 in which the flexible member comprises heat shrink tubing that is shrunken onto the body.

7. The weight of claim 6 in which the heat shrink tubing is longer than the body.

8. The weight of claim 7 in which the ends of the tubing are inside of the body.

9. The weight of claim 7 in which the tubing extends beyond both ends of the body.

10. The weight of claim 1 further comprising an adhesive between the inside of the body and the tool elongated body portion.

11. A weight for placement on a hand-held tool with an elongated body portion comprising:
a body comprising a length of pipe or a pipe nipple that defines a through-hole that is larger in diameter than the elongated body portion of the tool; and
a plastic sheath that covers and is coupled to the body and extends inward from the ends of the body such that it effectively decreases the through-hole diameter;
wherein the body and plastic sheath combination is placed onto the tool such that the elongated body portion of the tool protrudes from both ends of the body, with the flexible member frictionally engaging the elongated body portion.

12. The weight of claim 11 in which the plastic sheath comprises heat shrink tubing that is shrunken onto the body.

13. The weight of claim 12 in which the heat shrink tubing is longer than the body.

14. The weight of claim 12 in which the ends of the tubing are inside of the body.

15. The weight of claim 12 in which the tubing extends beyond both ends of the body.
